(19) United States
(12) Patent Application Publication
(10) Pub. No.: US 2026/0038205 A1
(43) Pub. Date: Feb. 5, 2026

(54) SIMULTANEOUS MAP AND DYNAMIC OBJECT RECONSTRUCTION FROM LIDAR

(71) Applicants: Robert Bosch GmbH, Stuttgart (DE); Carnegie Mellon University, Pittsburgh, PA (US)

(72) Inventors: Nathaniel CHODOSH, Pittsburgh, PA (US); Simon LUCEY, Pittsburgh, PA (US); Deva RAMANAN, Pittsburgh, PA (US); Chaithanya Kumar MUMMADI, Pittsburgh, PA (US); Filipe J. CABRITA CONDESSA, Pittsburgh, PA (US)

(21) Appl. No.: 18/791,565

(22) Filed: Aug. 1, 2024

(51) Int. Cl. G06T 17/20; G01S 17/89; G06T 7/20; G06T 7/70; G06V 20/70

(52) U.S. Cl. CPC G06T 17/20; G01S 17/89; G06T 7/20; G06T 7/70; G06V 20/70

(57) ABSTRACT

Systems and methods for simultaneous map dynamic object reconstruction using LIDAR are disclosed. A method includes generating point cloud data of an environment using a LIDAR system, and generating annotated frames based thereon, the first and second frames corresponding to first and second time points at a particular direction of the LIDAR. Intermediate frames between the first and second annotated frames are generated, and coordinate frame transformations are conducted for objects within the frames to determine respective positions and orientations. First and second optimizations are performed for a mesh of a three-dimensional space and positions/orientations within the space. The dynamic scene is reconstructed based on the optimizations.

### TECHNICAL FIELD

The present disclosure relates to dynamic scene reconstruction using LIDAR (Light Detection and Ranging) data, and more particularly, simultaneous reconstruction of motion through an environment of both static and dynamic objects.

### BACKGROUND

Some vehicles, such as autonomous (or self-driving) vehicles, utilize LIDAR as part of their navigation through an environment. The environment may include static objects (e.g., buildings), but may also include dynamic objects (e.g., other vehicles). Such vehicles may use dynamic scene reconstruction which aims to produce a model of the environment that is reflective of the gathered LIDAR data over time. In the context of depth-sensing sensors such as LIDAR, this problem may be posed as dynamic surface reconstruction, with a goal of producing time-varying surfaces that match a sequence of depth measurements. Using these reconstructions, an autonomous vehicle may more safely navigate through the environment.

### SUMMARY

The present disclosure is directed to systems and methods for simultaneous map dynamic object reconstruction using LIDAR. In one embodiment, a method includes generation of point cloud data using a LIDAR system implemented on a vehicle in an environment including a plurality of objects. Using the point cloud data, a plurality of frames are annotated, including first and second annotated frames that correspond to point cloud data generated at first and second time points, respectively. The method further includes estimating a position and orientation for one or more of the plurality of objects within the first and second annotated frames, and transforming global-referenced coordinates to vehicle-referenced coordinates for each of the one or more objects. Thereafter, the method includes generating, using the first and second annotated frames, a plurality of intermediate frames indicative of estimates of respective positions and orientations of the one or more objects between the first and second instances of time. The method then performs a transforming, for each of the one or more objects and using the plurality of intermediate frames, respective object-referenced coordinates to vehicle-reference coordinates. Following this transformation, the method includes performing first and second optimizations. The first optimization is performed for a mesh of the three-dimensional space, wherein, during the first optimization, the mesh of the three-dimensional space is dynamic and respective positions and orientations of the one or more objects are fixed. The second optimization is performed for respective positions and orientations of the one or more objects, wherein, during the second optimization, the mesh of the three-dimensional space is fixed and the respective positions and orientations of the one or more objects are dynamic. Based on the first and second optimizations, the method includes reconstructing the dynamic scene by repeating the performing the first and second optimizations until convergence.

### BRIEF DESCRIPTION OF THE DRAWINGS

FIG. 1 shows a system 100 for training a neural network.

FIG. 2 shows a computer-implemented method 200 for training a neural network.

FIG. 3 is a diagram illustrating one embodiment of a method for performing dynamic scene reconstruction.

4A is a drawing illustrating aspects of dynamic scene reconstruction per an embodiment of the disclosure.

FIG. 4B is a drawing illustrating further aspects of dynamic scene reconstruction per an embodiment of the disclosure.

FIG. 4C is a drawing illustrating further aspects of dynamic scene reconstruction per an embodiment of the disclosure.

FIG. 4D is a drawing illustrating further aspects of dynamic scene reconstruction per an embodiment of the disclosure.

FIG. 4E is a drawing illustrating further aspects of dynamic scene reconstruction per an embodiment of the disclosure.

FIG. 5 depicts a schematic diagram of an interaction between computer-controlled machine 510 and control system 512.

FIG. 6 depicts a schematic diagram of the control system of FIG. 1 configured to control a vehicle, which may be a partially autonomous vehicle or a partially autonomous robot.

FIG. 7 depicts a schematic diagram of the control system of FIG. 1 configured to control an automated mobile device.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative bases for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical application. Various combinations and modifications of the features consistent with the teachings of this disclosure, however, could be desired for particular applications or implementations.

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions.

Dynamic scene reconstruction is utilized by various types of automated mobile equipment and autonomous (or partially autonomous) vehicles to provide “visual” cues to enable navigation and avoid collisions. Many such dynamic scene reconstruction systems focus on highly deformable objects such as people and animals, which are very close to a sensor (e.g., LIDAR) used to sense the environment and provide data to perform the reconstruction. However, such systems may be unsuitable for the long-range and rigid world of autonomous driving scenes.

Another commonly used method, SLAM (Simultaneous Localization and Mapping) may create a dense surface reconstruction of a particular environment, but does not reconstruct challenging dynamic objects (e.g., moving vehicles).

Accordingly, existing methods focus on reconstructing a few densely scanned non-rigid objects, not the autonomous driving scenes that are typically composed of many sparsely-scanned rigid objects. Accordingly, the present disclosure is directed to a dynamic surface reconstruction system aimed at operating in a setting that includes sparsely scanned rigid objects, including static (non-moving objects) such as buildings as well as dynamic object (e.g., vehicles in motion).

The present disclosure addresses the dynamic scene reconstruction problem from an “analysis by synthesis” perspective, which a dense space-time reconstruction is synthesized via a compositional model of geometry and motion. The methodology may also measure the 3D error of the reconstruction with respect to the observed LIDAR scans. Optimization of the geometry and motion may then be carried out to minimize the 3D error. In various embodiments, the optimization is decomposed into alternating steps of 1) estimating 6-DOF (degree of freedom) motion parameters of rigidly-moving components (including the moving ego-vehicle) and 2) estimating the geometry of each rigid component (including the static background).

The methodology of the present disclosure includes generating point cloud data using a sensor such as LIDAR. A point cloud as defined herein is a collection of data points in space (e.g., gathered using LIDAR) the represent external surfaces of objects and/or features of the surrounding environment. Each point may have a particular distance and orientation relative to the origin of the LIDAR sensor. The point cloud data is gathered over time, and may be grouped into annotated frames that represent point cloud data as particular time instances. Linear interpolation and LIDAR odometry (defined herein as estimating changes in position of objects over time) are performed, with transformations of both static and dynamic objects from object and world coordinate systems, respectively, to the ego coordinate system are performed. Thereafter, iterations in which a mesh step and a pose step are performed. During the mesh step, the pose of various objects is held static (pose is defined herein as the position and orientation of an object in a given frame or set of data) while meshes may be dynamic. During the pose step, the pose for each object in the data set is dynamic, while the meshes are held static. The pose step and mesh step may be repeated for a number of iterations. This may allow for the generation of intermediate frames between the two annotated frames, wherein the intermediate frames represent the dynamic scene while the LIDAR scan was pointing in another direction. Thus, the methodology of the present disclosure may account for the “rolling shutter” effect of rotating LIDAR scanners in which the LIDAR is pointing in only one direction at any given point during the scan. Accordingly, the reconstructions carried out by the methodology of the present disclosure may account for moving objects (e.g., other vehicles) while also accounting for the static objects of the scene. Scene reconstructions may be carried out on a substantially continuous basis. A given scene reconstruction may include reconstruct the shapes of various objects within the environment (both static and dynamic), while also indicating their respective distances and orientations relative to the LIDAR sensor.

The dynamic scene reconstructions may provide annotations useful for tasks such as autonomous driving tasks. The methodology may further convert low frame-rate object annotations into high-frame rate annotations.

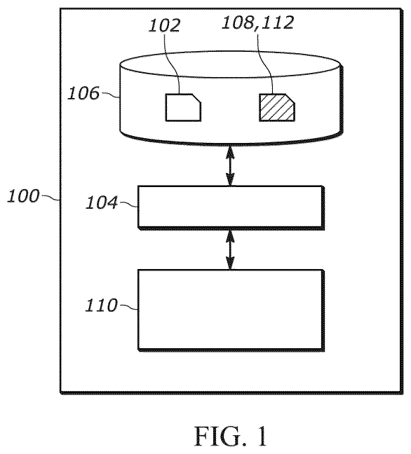

FIG. 1 shows a system 100 for training a neural network, e.g., a deep neural network. The neural network or deep neural networks shown and described are merely examples of the types of machine learning networks or neural networks that can be used. The system 100 may comprise an input interface for accessing training data 102 for the neural network. For example, as illustrated in FIG. 1, the input interface may be constituted by a data storage interface 104 which may access the training data 102 from a data storage 106. For example, the data storage interface 104 may be a memory interface or a persistent storage interface, e.g., a hard disk or an SSD interface, but also any suitable personal, local or wide area network interface such as a Bluetooth or Wi-Fi interface. The data storage 106 may be an internal data storage of the system 100, such as a hard drive or SSD, but also an external data storage, e.g., a network-accessible data storage. The neural network may, in one embodiment, be associated with an autonomous vehicle or a vehicular system that includes mapping and object reconstruction functions. For example, the neural network may operate in conjunction with a LIDAR system on a self-driving automobile in one example embodiment.

In some embodiments, the data storage 106 may further comprise a data representation 108 of an untrained version of the neural network which may be accessed by the system 100 from the data storage 106. It will be appreciated, however, that the training data 102 and the data representation 108 of the untrained neural network may also each be accessed from a different data storage, e.g., via a different subsystem of the data storage interface 104. Each subsystem may be of a type as is described above for the data storage interface 104. In other embodiments, the data representation 108 of the untrained neural network may be internally generated by the system 100 on the basis of design parameters for the neural network, and therefore may not explicitly be stored on the data storage 106. The system 100 may further comprise a processor subsystem 110 which may be configured to, during operation of the system 100, provide an iterative function as a substitute for a stack of layers of the neural network to be trained. Here, respective layers of the stack of layers being substituted may have mutually shared weights and may receive, as input, an output of a previous layer, or for a first layer of the stack of layers, an initial activation, and a part of the input of the stack of layers. The processor subsystem 110 may be further configured to iteratively train the neural network using the training data 102. Here, an iteration of the training by the processor subsystem 110 may comprise a forward propagation part and a backward propagation part. The processor subsystem 110 may be configured to perform the forward propagation part by, amongst other operations defining the forward propagation part which may be performed, determining an equilibrium point of the iterative function at which the iterative function converges to a fixed point, wherein determining the equilibrium point comprises using a numerical root-finding algorithm to find a root solution for the iterative function minus its input, and by providing the equilibrium point as a substitute for an output of the stack of layers in the neural network. The system 100 may further comprise an output interface for outputting a data representation 112 of the trained neural network, this data may also be referred to as trained model data 112. For example, as also illustrated in FIG. 1, the output interface may be constituted by the data storage interface 104, with said interface being in these embodiments an input/output (‘IO’) interface, via which the trained model data 112 may be stored in the data storage 106. For example, the data representation 108 defining the ‘untrained’ neural network may during or after the training be replaced, at least in part by the data representation 112 of the trained neural network, in that the parameters of the neural network, such as weights, hyper parameters and other types of parameters of neural networks, may be adapted to reflect the training on the training data 102. This is also illustrated in FIG. 1 by the reference numerals 108, 112 referring to the same data record on the data storage 106. In other embodiments, the data representation 112 may be stored separately from the data representation 108 defining the ‘untrained’ neural network. In some embodiments, the output interface may be separate from the data storage interface 104, but may in general be of a type as described above for the data storage interface 104.

As noted above, various embodiments of the system for training a neural network may be implemented in a system for performing reconstruction of a dynamic scene reconstruction in a dynamic environment such as that encountered by a self-driving automobile or other automated vehicle. Training data may be gathered using various types of sensors, such as LIDAR, and may be matched with maps of a particular are from where the data is gathered.

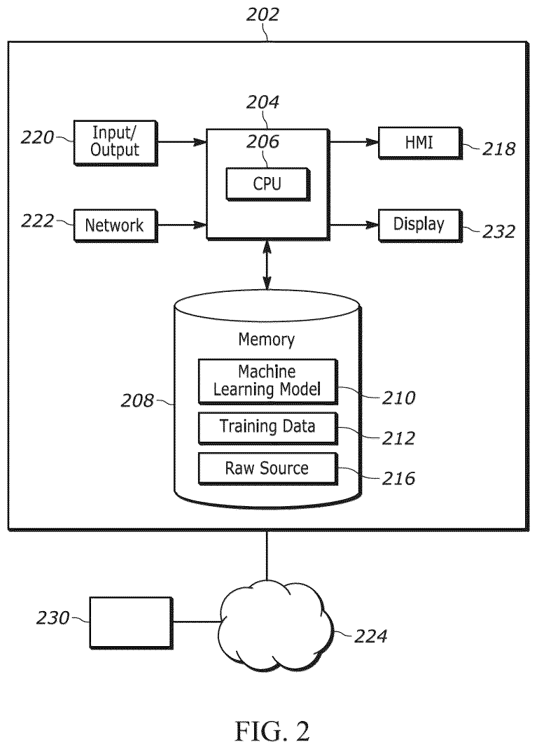

FIG. 2 depicts a system 200 to implement the machine learning models described herein, for example the deep neural networks used in autonomous vehicles and which utilize data and dynamic scene reconstruction based therein. Other types of machine learning models can be used, and the DNNs described herein are not the only types of machine learning models capable of being used in the system of this disclosure. For example, if the input image contains an ordered sequence of pixels after converting CSI values to pixels in an image), a CNN may be utilized. The system 200 can be implemented to perform one or more of the phases of image recognition described herein. The system 200 may include at least one computing system 202. The computing system 202 may include at least one processor 204 that is operatively connected to a memory unit 208. The processor 204 may include one or more integrated circuits that implement the functionality of a central processing unit (CPU) 206. The CPU 206 may be a commercially available processing unit that implements an instruction set such as one of the x86, ARM, Power, or MIPS instruction set families. During operation, the CPU 206 may execute stored program instructions that are retrieved from the memory unit 208. The stored program instructions may include software that controls operation of the CPU 206 to perform the operation described herein. In some examples, the processor 204 may be a system on a chip (SoC) that integrates functionality of the CPU 206, the memory unit 208, a network interface, and input/output interfaces into a single integrated device. The computing system 202 may implement an operating system for managing various aspects of the operation. While one processor 204, one CPU 206, and one memory 208 is shown in FIG. 2, of course more than one of each can be utilized in an overall system.

The memory unit 208 may include volatile memory and non-volatile memory for storing instructions and data. The non-volatile memory may include solid-state memories, such as NAND flash memory, magnetic and optical storage media, or any other suitable data storage device that retains data when the computing system 202 is deactivated or loses electrical power. The volatile memory may include static and dynamic random-access memory (RAM) that stores program instructions and data. For example, the memory unit 208 may store a machine learning model 210 or algorithm, a training dataset 212 for the machine learning model 210, raw source dataset 216.

The computing system 202 may include a network interface device 222 that is configured to provide communication with external systems and devices. For example, the network interface device 222 may include a wired and/or wireless Ethernet interface as defined by Institute of Electrical and Electronics Engineers (IEEE) 802.11 family of standards. The network interface device 222 may include a cellular communication interface for communicating with a cellular network (e.g., 3G, 4G, 5G). The network interface device 222 may be further configured to provide a communication interface to an external network 224 or cloud.

The external network 224 may be referred to as the world-wide web or the Internet. The external network 224 may establish a standard communication protocol between computing devices. The external network 224 may allow information and data to be easily exchanged between computing devices and networks. One or more servers 230 may be in communication with the external network 224.

The computing system 202 may include an input/output (I/O) interface 220 that may be configured to provide digital and/or analog inputs and outputs. The I/O interface 220 is used to transfer information between internal storage and external input and/or output devices (e.g., HMI devices). The I/O 220 interface can includes associated circuitry or BUS networks to transfer information to or between the processor(s) and storage. For example, the I/O interface 220 can include digital I/O logic lines which can be read or set by the processor(s), handshake lines to supervise data transfer via the I/O lines; timing and counting facilities, and other structure known to provide such functions. Examples of input devices include a keyboard, mouse, sensors, etc. Examples of output devices include monitors, printers, speakers, etc. The I/O interface 220 may include additional serial interfaces for communicating with external devices (e.g., Universal Serial Bus (USB) interface). The I/O interface 220 can be referred to as an input interface (in that it transfers data from an external input, such as a sensor), or an output interface (in that it transfers data to an external output, such as a display).

The computing system 202 may include a human-machine interface (HMI) device 218 that may include any device that enables the system 200 to receive control input. Examples of input devices may include human interface inputs such as keyboards, mice, touchscreens, voice input devices, and other similar devices. The computing system 202 may include a display device 232. The computing system 202 may include hardware and software for outputting graphics and text information to the display device 232. The display device 232 may include an electronic display screen, projector, printer or other suitable device for displaying information to a user or operator. The computing system 202 may be further configured to allow interaction with remote HMI and remote display devices via the network interface device 222.

The system 200 may be implemented using one or multiple computing systems. While the example depicts a single computing system 202 that implements all of the described features, it is intended that various features and functions may be separated and implemented by multiple computing units in communication with one another. The particular system architecture selected may depend on a variety of factors.

The system 200 may implement a machine learning algorithm 210 that is configured to analyze the raw source dataset 216. The raw source dataset 216 may include raw or unprocessed sensor data that may be representative of an input dataset for a machine learning system. The raw source dataset 216 may include video, video segments, images, text-based information, audio or human speech, time series data (e.g., a pressure sensor signal over time), raw or partially processed sensor data (e.g., radar map of objects), wireless signals in terms of CSI, RSSI, CIR. Moreover, the raw source dataset 216 may be input data derived from an associated sensor such as a camera, LIDAR, radar, ultrasonic sensor, motion sensor, thermal imaging camera, wireless receivers, or any other type of sensor that produces associated data with spatial dimensions where there is some notion of a “foreground” and a “background” within those spatial dimensions. References to an input or input “image” herein is not necessarily from a camera, but can be from any of the above-listed sensors. In some examples, the machine learning algorithm 210 may be a neural network algorithm (e.g., deep neural network) that is designed to perform a predetermined function. For example, the neural network algorithm may be configured to control the operation of a self-driving car, using reconstructed scenes generated using LIDAR data along with previous learning regarding particular environments as presented on a map.

The computer system 200 may store a training dataset 212 for the machine learning algorithm 210. The training dataset 212 may represent a set of previously constructed data for training the machine learning algorithm 210. The training dataset 212 may be used by the machine learning algorithm 210 to learn weighting factors associated with a neural network algorithm. The training dataset 212 may include a set of source data that has corresponding outcomes or results that the machine learning algorithm 210 tries to duplicate via the learning process. In the dynamic scene reconstruction example of the present disclosure, the training dataset 212 may include previously gathered sensor data (e.g., LIDAR data) along with previously gathered data from mapping and navigation inputs (e.g., from GPS).

The machine learning algorithm 210 may be operated in a learning mode using the training dataset 212 as input. The machine learning algorithm 210 may be executed over a number of iterations using the data from the training dataset 212. With each iteration, the machine learning algorithm 210 may update internal weighting factors based on the achieved results. For example, the machine learning algorithm 210 can compare output results (e.g., a reconstructed or supplemented image, in the case where image data is the input) with those included in the training dataset 212. Since the training dataset 212 includes the expected results, the machine learning algorithm 210 can determine when performance is acceptable. After the machine learning algorithm 210 achieves a predetermined performance level (e.g., 100% agreement with the outcomes associated with the training dataset 212), or convergence, the machine learning algorithm 210 may be executed using data that is not in the training dataset 212. It should be understood that in this disclosure, “convergence” can mean a set (e.g., predetermined) number of iterations have occurred, or that the residual is sufficiently small (e.g., the change in the approximate probability over iterations is changing by less than a threshold), or other convergence conditions. The trained machine learning algorithm 210 may be applied to new datasets to generate annotated data.

The machine learning algorithm 210 may be configured to identify a particular feature in the raw source data 216. The raw source data 216 may include a plurality of instances or input dataset for which supplementation results are desired. For example, the machine learning algorithm 210 may be configured to identify the presence of a particular building or structure in video images and annotate the occurrences. In another example, the machine learning algorithm 210 may be configured to correlate data gathered from sensors such as LIDAR with mapping data gathered from, e.g., GPS, during a drive-through when training for a self-driving automobile. The machine learning algorithm may also learn to distinguish static structures (e.g., buildings, sign posts, lamp posts, etc.) from dynamic objects, such as other vehicles when driving through a particular area for which the training is being conducted.

The raw source data 216 may be derived from a variety of sources. For example, the raw source data 216 may be actual input data collected by a machine learning system. The raw source data 216 may be machine generated for testing the system. As an example, the raw source data 216 may include raw LIDAR data, video images from a camera, and GPS data.

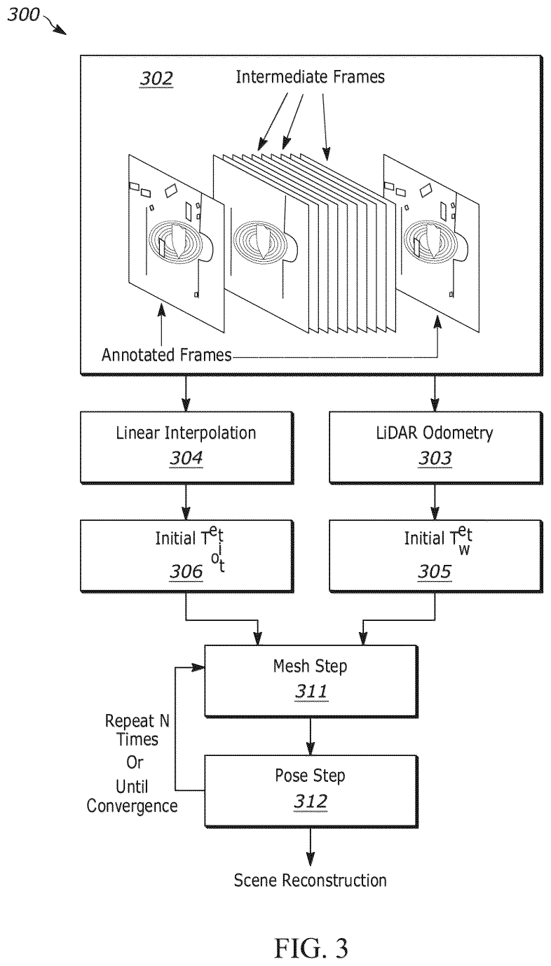

FIG. 3 is a diagram illustrating one embodiment of a method for performing dynamic scene reconstruction. Method 300 may be carried out by various ones of the systems discussed above with reference to FIGS. 1 and 2, or any other suitable system. Furthermore, Method 300 may be carried out in the context of a vehicle using a LIDAR sensors, or other types of mobile equipment for which dynamic scene reconstruction of the surrounding environment is utilized in navigation.

In the embodiment shown of FIG. 3, Method 300 includes the generation of a plurality of frames 302, including first and second annotated frames. As will be explained in further detail below, the annotated frames represent frames of point cloud data gathered at a particular point in time at a particular direction, while the intermediate frames represent an interpolation of point cloud data between these times. Method 300 further includes performing a linear interpolation 304 and a first coordinate transformation 306, along with LIDAR odometry 303 and another coordinate transformation 305. As depicted here, linear interpolation 304 and coordinate transformation 306 may be performed in parallel with LIDAR odometry 303 and coordinate transformation 305. Based on the performance of these previous steps, optimizations comprising a mesh step 311 and a pose step 312 are performed. These steps may be performed a predetermined number of times, or may be performed until a convergence is reached (e.g., when an error between successive iterations is less than a threshold value). Based on these optimizations, a scene reconstruction is carried out. Method 300 may be performed continuously, with the scene reconstructions being used in controlling the operation of a self-driving vehicle or other type of mobile unit. A more detailed discussion of one particular embodiment of the methodology disclosed herein now follows.

In various embodiments, the method for dynamic scene reconstruction uses, as an input, a sequence of LIDAR sweeps measured at timestamps t E T (where tis an individual timestamp that is an element in the set of timestamps 7), and coarse tracks of K objects. Since the method uses a compositional model of the scene, a coordinate frame may be found for each component.

A first coordinate system used in the dynamic reconstruction is referred to as an ego coordinate frame. This coordinate frame is referenced to the sensor, such as a LIDAR mounted on a self-driving automobile, with the z-axis pointing along the axis of rotation. This coordinate frame may change over time as the vehicle moves. The coordinate frame at time t is designated herein at et.

A second coordinate frame used in the dynamic reconstruction is referred to as the object coordinate frame. In this coordinate frame, each object is at the origin, with the z-direction being up and the x-direction being forward. This coordinate system may also vary with time (particularly for objects in motion). We will denote the i th object's coordinate frame at time t as

$${O}_{t}^{i} .$$

A third coordinate frame used in the dynamic scene reconstruction is referred to as the world coordinate frame. This is a fixed, global coordinate frame of the scene and is designated as w. Due to the global coordinate frame ambiguity, this coordinate frame may be considered equal to e₁.

To indicate the coordinate frame of given point x, or set of points X, subscripts are used. For example, the input points are written as xₑ_{ₜ},Xₑ_{ₜ}. The relationship between these coordinate frames may be expressed using 4×4 rigid transformation matrices T. Superscripts and subscripts on these transformations are used determine which coordinate frames are being related. For example, the transformation from sensor coordinates at time t to world coordinates may be written as

$${T}_{{e}_{t}}^{w} .$$

Similarly, the transformation from world coordinates to object i at time t may be written as

$${T}_{w}^{{O}_{t}^{i}} .$$

Then, transformation from the ith object's coordinate system at time t to the sensor coordinates at time t may be written as

$${T}_{{e}_{t}}^{{O}_{t}^{i}} = {T}_{w}^{{O}_{t}^{i}} {T}_{{e}_{t}}^{w} .$$

The scene may be decomposed into a set of a set of surfaces that transform rigidly over time. In one embodiment, triangular meshes are used, although other types of meshes are possible and contemplated within the scope of this disclosure. The methodology includes a mesh for the background and for each of the K objects in the scene, which is written here as

$${\{ {M}_{i} \}}_{i = 0}^{k} . {M}_{0}$$

refers to the background mesh.

The term TM is used herein to denote the transforming of the vertices of M by the transformation T. Similarly, the term TX is used herein to express transforming the points X. The union of these two meshes may be written as [M₁, M₂]. The measurement of the distance between a mesh and a point cloud using the nearest neighbor loss may be expressed as follows:

$$𝒟 ( ℳ , X ) = {\sum }_{x ∈ X} {min}_{m ∈ ℳ} ‖ m - x ‖ . \qquad ( 1 )$$

The method may, in one embodiment, find the surfaces and 6DOF motion parameters of those surfaces that, when composed together at each timestamp, match the measured point cloud. When the point clouds are measured in ego coordinates, the meshes are thus transformed into the ego coordinate frame. Consider a scene composed of background M₀ and a single object M₁, then our reconstruction for t=1 would be:

$$[ {T}_{w}^{{e}_{1}} {M}_{0} , {T}_{{O}_{1}^{1}}^{{e}_{1}} {M}_{1} ] .$$

To generate an error signal for an optimization, the reconstruction is compared to the measured point Xₑ_{₁} using the nearest neighbor distance. In the method of generating the reconstruction in the present disclosure, the errors are summed over all timestamps and the K meshes are composed together. That is, our method optimizes the objective:

$${min}_{\{ {ℳ}_{i} . {T}_{{O}_{1}^{1}}^{{e}_{1}} , {T}_{w}^{{e}_{1}} \}} {\sum }_{t ∈ 𝒯} 𝒟 ( [ {T}_{w}^{{e}_{t}} {ℳ}_{0} , {T}_{{O}_{t}^{1}}^{{e}_{t}} {ℳ}_{1} , … , {T}_{{O}_{t}^{K}}^{{e}_{t}} {ℳ}_{K} ] , {X}_{{e}_{t}} ) . \qquad ( 2 )$$

In the decomposition, Xₑ_{ₜ}ⁱ denotes the subset of points from Xₑ_{ₜ} which fall on object i. Once the poses of the bounding boxes are refined, this step may be re-computed to get new assignments. Using this notation, Eq.(2) may be rewritten as follows:

$${min}_{\{ {ℳ}_{i} , {T}_{{O}_{t}^{i}}^{{e}_{t}} , {T}_{w}^{{e}_{t}} \}} {\sum }_{t ∈ 𝒯} {\sum }_{i = 0}^{K} 𝒟 ( {T}_{{O}_{t}^{i}}^{{e}_{t}} {ℳ}_{i} , {X}_{{e}_{t}}^{i} ) \qquad ( 3 )$$

where oₜ⁰=w.

As noted above and illustrated in FIG. 3, methodology includes applying coordinate descent alternating between fixing the poses to optimize the meshes and then fixing the meshes to update the poses. These stages are the mesh step 311 and post step 312, respectively. The coarse bounding boxes are used to initialize

$${T}_{{O}_{t}^{i}}^{{e}_{t}}$$

and an appropriate LIDAR method is used to initialize

$${T}_{w}^{{e}_{t}}$$

It is noted that the methodology of the present disclosure does not require any initialization of the meshes.

The mesh step in one embodiment is described as follows. Assuming fixed poses, estimation of new meshes may be carried out by solving the following:

$${ℳ}_{i} ← arg {min}_{{ℳ}_{\text{?}}} {\sum }_{t ∈ 𝒯} 𝒟 ( {T}_{\text{?}}^{\text{?}} {ℳ}_{i} , {X}_{{e}_{t}}^{i} ) = arg {min}_{{ℳ}_{i}} {\sum }_{t ∈ 𝒯} 𝒟 ( {ℳ}_{i} , {( {T}_{{o}_{t}^{i}}^{{e}_{t}} )}^{- 1} {X}_{{e}_{t}}^{i} ) = arg {min}_{{ℳ}_{i}} 𝒟 ( {ℳ}_{i} , [ {( {T}_{{o}_{t}^{i}}^{{e}_{t}} )}^{- 1} {X}_{{e}_{t}}^{i} , … ] ) . \qquad ( 4 )$$

$$\text{?} \text{indicates text missing or illegible when filed}$$

The final form of equation (4) in the example shown is obtained by making use of two identities related to the nearest neighbor distance. The distance may remain unaffected by a global rigid transformation to see that D(TM, X)=D(M, T⁻¹X). Furthermore, if a set of points is written X=[X₁, X₂] as a union of two disjoint sets X₁ and X₂, it thus follows that D(M, [X₁, X₂])=D(M, X₁)+D(M, X₂). The final form of this equation can be interpreted as a standard static point-to-surface reconstruction problem. The equation may be solved in various ways, such as through the use of neural kernel surface reconstruction. Neural surface reconstruction according to the disclosure includes taking multiple images of a target object/scene, neural rendering, and surface reconstruction. The multiple images may be taken using, e.g., LIDAR, at different angels, particularly in vehicle applications in which the sensor is moving. Neural rendering may then be used in which a neural networks interprets the images and estimates surface geometries of objects within the images. Thereafter, surface reconstruction is carried out by generating continuous 3D surfaces that align with the visual data from the images.

The pose step for one embodiment is described as follows. Assuming fixed poses, new poses can be estimated by solving the following:

$${T}_{{o}_{t}^{i}}^{{e}_{t}} ← arg {min}_{{T}_{\text{?}}^{\text{?}}} 𝒟 ( {T}_{\text{?}}^{\text{?}} {ℳ}_{i} , {X}_{\text{?}}^{i} ) = arg {min}_{{T}_{\text{?}}^{\text{?}}} 𝒟 ( {ℳ}_{i} , {( {T}_{{o}_{t}^{i}}^{{e}_{t}} )}^{- 1} {X}_{{e}_{t}}^{i} ) . \qquad ( 5 )$$

$$\text{?} \text{indicates text missing or illegible when filed}$$

This is a point-to-mesh registration problem may be solved using an Iterative Closest Point (ICP) method, which is used to minimize the difference between two different point clouds. The ICP methodology in various embodiments is iterative, repeating iterations until the alignment of the two point clouds cannot be improved further, according to a chosen error metric.

Generally speaking, the method includes a LIDAR system generating point cloud data for a surrounding environment in which a plurality of objects, both static and dynamic, are present. The static objects may include buildings and other structures, light poles, utility poles, and virtually any other type of non-moving structure. The dynamic object may comprise various types of vehicles that may be in motion within the environment. The point cloud data gathered using the LIDAR system comprises a plurality of points in the three-dimensional space of the environment.

After gathering the point cloud data, the method further includes annotating a plurality of frames based on (and using) the point cloud data. More particularly, each annotated frame may represent point cloud data at a particular instance of time, and further, in a particular direction in the case when the LIDAR system has a rotating sensor. Thus, a first annotated frame and a second annotated frame (subsequent and consecutive to the first) may thus represent point cloud data at two consecutive instances of time at a particular direction as the LIDAR sensor rotates.

For each of the annotated frames (including the first and second), the method includes estimating respective positions and orientations for one or more objects of the plurality of objects within the point cloud data of the frames. After the position estimations for the objects, the method carries out a transformation for the objects from a global-referenced coordinates to vehicle-referenced coordinates. The method may also include transformations from object-referenced coordinates to vehicle-referenced coordinates for the various objects. The transformation to vehicle-referenced coordinates allows for scene reconstruction to be carried out from the perspective of the vehicle upon which the LIDAR sensor is mounted.

Since the LIDAR sensor is rotating in the methodology disclosed herein, information in a particular direction is only captured at discrete points in time, e.g., as represented by the first and second annotated frames. The information between these two points in time is not captured by the LIDAR sensor, but may be important for scene reconstruction in a dynamic environment and in particularly, from the perspective of a moving vehicle upon which the LIDAR sensor is mounted. This may be referred to as the rolling shutter problem. The methodology disclosed herein may interpolated between two consecutive annotated frames (e.g., the first and second frames of the example above) to generate a plurality of intermediate frames that indicative of estimated respective positions and orientations of objects between the first and second instances of time (when the LIDAR system is not pointing in the particular direction associated with the first and second annotated frames). In some embodiments, this may include assuming a substantially constant velocity for dynamic objects that are present in both the first and second annotated frames.

The methodology further includes performing first and second optimizations. These optimizations may be performed using consecutive first and second frames of point cloud data, as well as intermediate frames generated as described above. A first optimization carried out in performing the method is to a mesh of the three-dimensional space. During this optimization, the mesh of the three-dimensional space is dynamic, while respective positions and orientations of the one or more objects are held as fixed. Accordingly, the method includes generating meshes for the various non-moving objects as well as the moving objects. For the moving objects, a constant velocity of motion is assumed.

The second optimization is to the respective positions and orientations of the objects. During this second optimization, the mesh of the three-dimensional space is held as fixed, while the respective positions and orientations of the objects are dynamic. The dynamic scene reconstruction for the time period between the first and second frames may then be completed by repeating the first and second optimizations to a convergence. In some embodiments, this convergence may comprise repeating the first and second optimizations a predetermined number of times. In other embodiments, the optimizations may be performed until an error metric (e.g., a difference in values from one iteration to the next) is less than some error threshold.

In various embodiment, the scene reconstructions may be used to control a self-driving vehicle. For example, based on the detections of various objects in the surrounding environment, a control system in a vehicle may use the scene reconstructions to avoid collisions and adjust its path. More generally, the scene reconstructions may be used with other information, such as global positioning system (GPS) navigation data and visual sensor information to adjust the path and speed of the vehicle, to stop at certain locations (e.g., at intersections with stop signs or traffic signals), and so on. The disclosure contemplates that other mobile units, such as a mobile robot, may also utilize the methodology of the present disclosure to control and adjust its motion. For example, a mobile robot in a factory may utilize the methodology to transfer parts from one portion of the factory (e.g., a parts room) to another location on an assembly line where such parts would be needed to keep operations flowing.

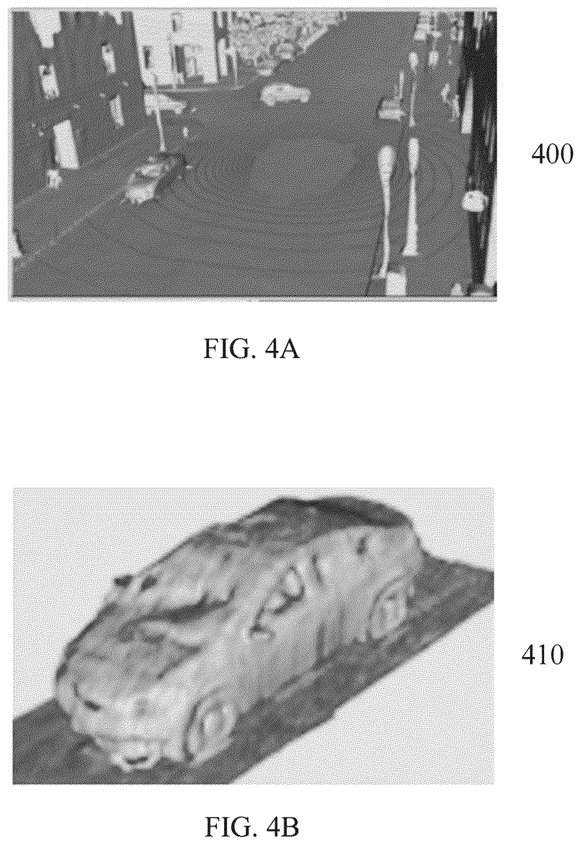

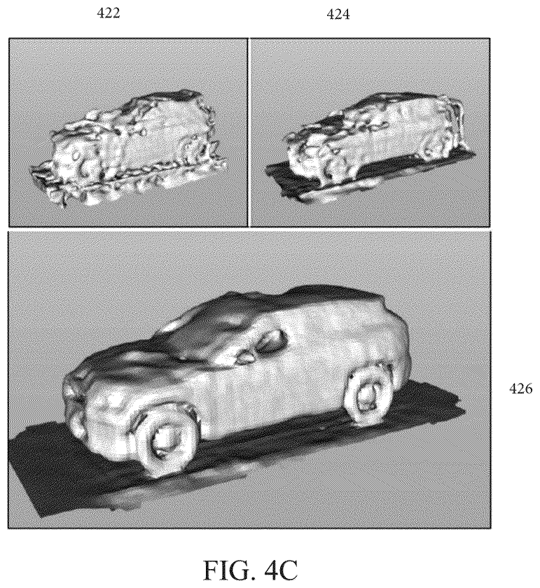

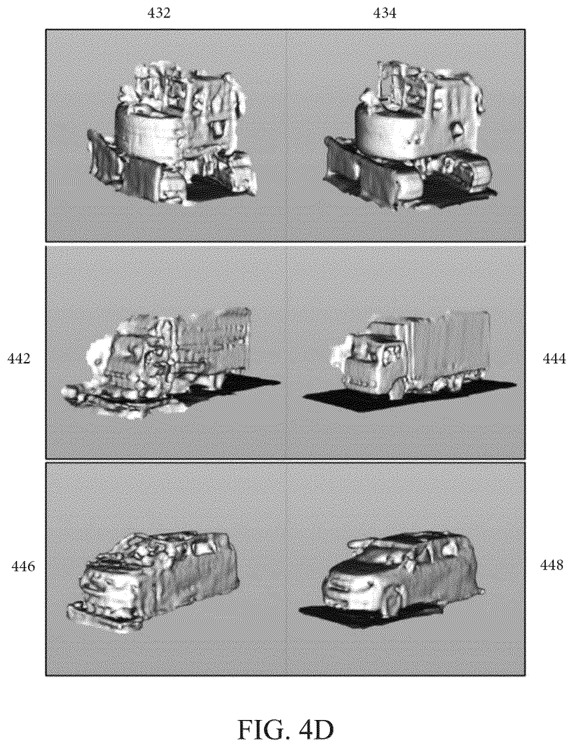

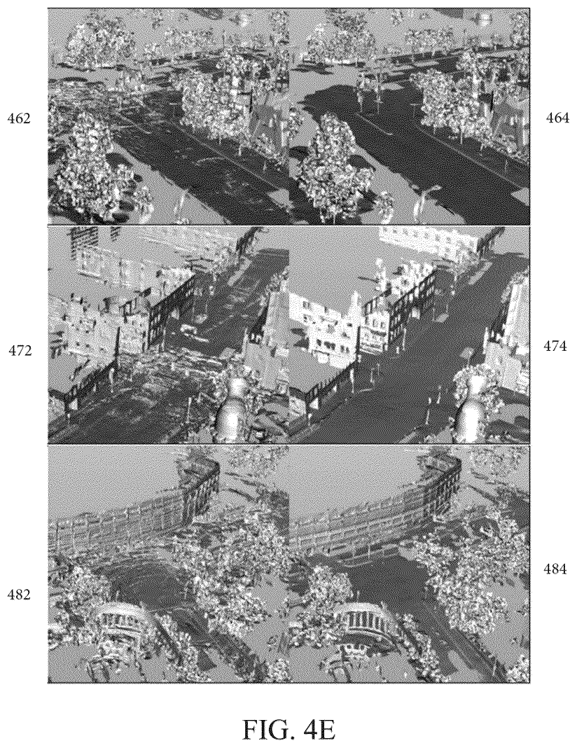

FIG. 4A is a drawing illustrating aspects of dynamic scene reconstruction per an embodiment of the disclosure. In particular, FIG. 4A illustrates a dynamic environment, as depicted by a scene reconstruction 400 that may be carried out by the methodology of the present disclosure. In contrast to scene reconstructions that aggregate background and object points into common reference frames and then carry out a point-to-surface reconstruction algorithm, the present disclosure performs an optimization that refines both ego poses (that is, a position and orientation of the sensor, such as a LIDAR on the vehicle) and object poses. It is noted that in performing the LIDAR sweeps, the data may be plotted differently for background/static points (e.g., buildings) and dynamic points (e.g., points on moving vehicles).

FIG. 4B is a drawing illustrating further aspects of dynamic scene reconstruction per an embodiment of the disclosure. This particular example illustrates a dynamic object in the form of a moving vehicle, and includes effects of compensating for the rolling shutter problem in which the rotating LIDAR sensor is pointing in only one direction at any given instant in time. Accordingly, the generation of the intermediate frames as described above may compensate for the rolling shutter problem to yield a more accurate scene reconstruction when moving objects are present therein.

FIG. 4C is a drawing illustrating further aspects of dynamic scene reconstruction per an embodiment of the disclosure. More particularly, FIG. 4C illustrates the individual effects of the optimizations performed along with the combined effect obtained in accordance with the methodology of the present disclosure. To achieve for high-quality reconstructions, the methodology of the present disclosure accounts for intra-sweep motion in generating the intermediate frames (and thus solving for the rolling shutter problem). This is accomplished by the optimizations discussed above.

In 422 of FIG. 4C, a reconstruction of a vehicle with neither refined poses nor motion compensation is shown. In 424, the reconstruction of the vehicle using refined poses but without motion compensation is shown. In 426, the combination of both reconstructions, as carried out by the methodology of the disclosure, is shown. This combination is carried out by the mesh step 311 and pose step 312 of FIG. 3 per the description above, and therefore may yield a more high-quality reconstruction.

FIG. 4D is a drawing illustrating further aspects of dynamic scene reconstruction per an embodiment of the disclosure. Each pair of images (432-434, 442-444, and 446-448) shown represents a comparison between the utilization of ground truth poses relative to the methodology described herein. The ground truth poses shown (432, 442, and 446) are generated using static poses, in contrast to the pose step disclosed herein in which the optimization is carried out using dynamic poses. Accordingly, the use of dynamic poses (in the pose step, along with dynamic meshes in the mesh step) may allow for reconstructions in which the vehicles shown in each pair are moving without sacrificing accuracy and yielding a higher quality reconstruction, as shown in 434, 444, and 454.

FIG. 4E is a drawing illustrating further aspects of dynamic scene reconstruction per an embodiment of the disclosure. In the example of FIG. 4E, the respective pairs (462-464, 472-474, and 482-484) illustrate reconstructions of various static objects in a dynamic scene using solely LIDAR odometry poses in comparison with reconstructions of these same objects using the methodology of the present disclosure. As shown in comparison, the images on the right (464, 474, and 484) suffer from less distortion and have a higher degree of clarity and accuracy than those shown on the left (462, 472, and 482). During the mesh step 311, as discussed above in reference to FIG. 3, the respective poses of objects in a scene may be held static while the respective meshes may be dynamic. This may, in turn, allow for more accuracy in the reconstructions of objects in the scene, both static (e.g., non-moving structures) as well as dynamic (e.g., moving vehicles).

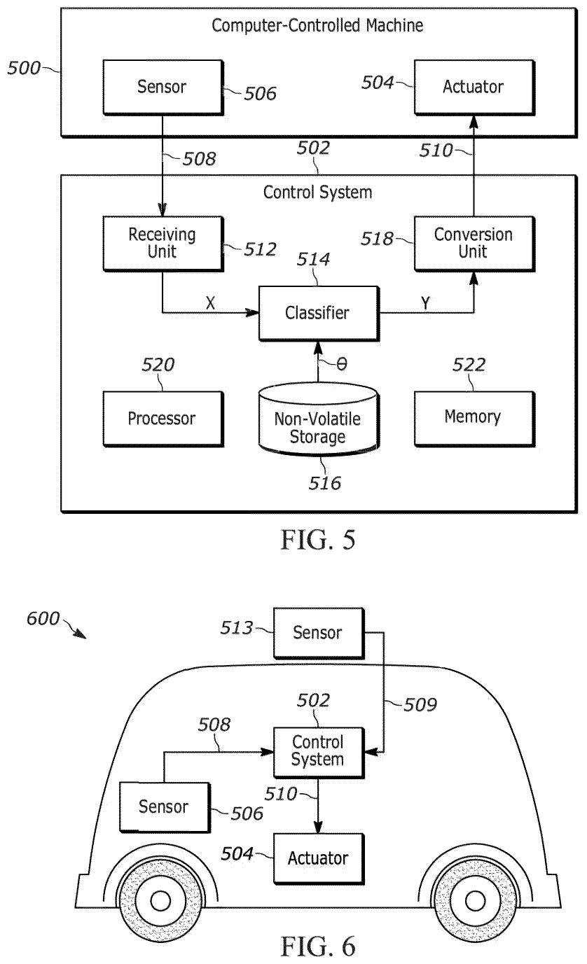

FIG. 5 depicts a schematic diagram of an interaction between a computer-controlled machine 500 and a control system 502. Computer-controlled machine 500 includes actuator 504 and sensor 506. Actuator 504 may include one or more actuators and sensor 506 may include one or more sensors. Sensor 506 is configured to sense a condition of computer-controlled machine 500. Sensor 506 may be configured to encode the sensed condition into sensor signals 508 and to transmit sensor signals 508 to control system 502. Non-limiting examples of sensor 506 include wireless receivers, video, radar, LIDAR, ultrasonic and motion sensors, as described above with reference to FIGS. 1-2. In one embodiment, sensor 506 is a LIDAR used for gathering data to enable dynamic scene reconstruction in applications such as autonomous/self-driving vehicles.

Control system 502 is configured to receive sensor signals 508 from computer-controlled machine 500. As set forth below, control system 502 may be further configured to compute actuator control commands 510 depending on the sensor signals and to transmit actuator control commands 510 to actuator 504 of computer-controlled machine 500.

As shown in FIG. 5, control system 502 includes receiving unit 512. Receiving unit 512 may be configured to receive sensor signals 508 from sensor 506 and to transform sensor signals 508 into input signals x. In an alternative embodiment, sensor signals 508 are received directly as input signals x without receiving unit 512. Each input signal x may be a portion of each sensor signal 508. Receiving unit 512 may be configured to process each sensor signal 508 to product each input signal x. Input signal x may include data corresponding to an image recorded by sensor 506.

Control system 502 includes a classifier 514. Classifier 514 may be configured to classify input signals x into one or more labels using a machine learning (ML) algorithm, such as a neural network described above. Classifier 514 is configured to be parametrized by parameters, such as those described above (e.g., parameter θ). Parameters θ may be stored in and provided by non-volatile storage 516. Classifier 514 is configured to determine output signals y from input signals x. Each output signal y includes information that assigns one or more labels to each input signal x. Classifier 514 may transmit output signals y to conversion unit 518. Conversion unit 518 is configured to covert output signals y into actuator control commands 510. Control system 502 is configured to transmit actuator control commands 510 to actuator 504, which is configured to actuate computer-controlled machine 500 in response to actuator control commands 510. In another embodiment, actuator 504 is configured to actuate computer-controlled machine 500 based directly on output signals y.

Upon receipt of actuator control commands 510 by actuator 504, actuator 504 is configured to execute an action corresponding to the related actuator control command 510. Actuator 504 may include a control logic configured to transform actuator control commands 510 into a second actuator control command, which is utilized to control actuator 504. In one or more embodiments, actuator control commands 510 may be utilized to control a display instead of or in addition to an actuator. In various embodiments, actuator 504 may be a system for driving a vehicle or other type of mobile equipment. For example, actuator 504 may be configured for driving a self-driving automobile, performing the various functions such as steering, accelerating, braking, and so on. The control commands may be generated at least in part on data obtained from sensor 506, which may perform functions such as dynamic scene reconstruction (e.g., of the environment through which the vehicle is driving) as well as navigation.

In another embodiment, control system 502 includes sensor 506 instead of or in addition to computer-controlled machine 500 including sensor 506. Control system 502 may also include actuator 504 instead of or in addition to computer-controlled machine 500 including actuator 504.

As shown in FIG. 5, control system 502 also includes processor 520 and memory 522. Processor 520 may include one or more processors. Memory 522 may include one or more memory devices. The classifier 514 (e.g., machine learning algorithms, such as those described above with regard to pre-trained classifier 306) of one or more embodiments may be implemented by control system 502, which includes non-volatile storage 516, processor 520 and memory 522.

Non-volatile storage 516 may include one or more persistent data storage devices such as a hard drive, optical drive, tape drive, non-volatile solid-state device, cloud storage or any other device capable of persistently storing information. Processor 520 may include one or more devices selected from high-performance computing (HPC) systems including high-performance cores, microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on computer-executable instructions residing in memory 522. Memory 522 may include a single memory device or a number of memory devices including, but not limited to, random access memory (RAM), volatile memory, non-volatile memory, static random access memory (SRAM), dynamic random access memory (DRAM), flash memory, cache memory, or any other device capable of storing information.

Processor 520 may be configured to read into memory 522 and execute computer-executable instructions residing in non-volatile storage 516 and embodying one or more ML algorithms and/or methodologies of one or more embodiments. Non-volatile storage 516 may include one or more operating systems and applications. Non-volatile storage 516 may store compiled and/or interpreted from computer programs created using a variety of programming languages and/or technologies, including, without limitation, and either alone or in combination, Java, C, C++, C#, Objective C, Fortran, Pascal, Java Script, Python, Perl, and PL/SQL.

Upon execution by processor 520, the computer-executable instructions of non-volatile storage 516 may cause control system 502 to implement one or more of the ML algorithms and/or methodologies as disclosed herein. Non-volatile storage 516 may also include ML data (including data parameters) supporting the functions, features, and processes of the one or more embodiments described herein.

The program code embodying the algorithms and/or methodologies described herein is capable of being individually or collectively distributed as a program product in a variety of different forms. The program code may be distributed using a computer readable storage medium having computer readable program instructions thereon for causing a processor to carry out aspects of one or more embodiments. Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. Computer readable program instructions may be downloaded to a computer, another type of programmable data processing apparatus, or another device from a computer readable storage medium or to an external computer or external storage device via a network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions, acts, and/or operations specified in the flowcharts or diagrams. In certain alternative embodiments, the functions, acts, and/or operations specified in the flowcharts and diagrams may be re-ordered, processed serially, and/or processed concurrently consistent with one or more embodiments. Moreover, any of the flowcharts and/or diagrams may include more or fewer nodes or blocks than those illustrated consistent with one or more embodiments.

The processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

FIG. 6 depicts a schematic diagram of control system 502 configured to control vehicle 600, which may be an at least partially autonomous vehicle or an at least partially autonomous robot. Vehicle 600 includes actuator 504 and sensors 506 and 513. Sensors 506 and 513 may include one or more video sensors, cameras, radar sensors, ultrasonic sensors, wireless transmitters and/or receivers, LIDAR sensors, and/or position sensors (e.g., GPS). One or more of the one or more specific sensors may be integrated into vehicle 600. Alternatively or in addition to one or more specific sensors identified above, sensor 506 may include a software module configured to, upon execution, determine a state of actuator 504. In one embodiment, sensor 513 may be a LIDAR sensor on top of the vehicle, while sensor 506 may include a receiver configured to receive GPS signals. It is further noted that each of sensors 506 and 513 may encompass multiple receivers. Accordingly, while sensor 513 may be a LIDAR sensor, sensor 506 may include the previously mentioned GPS sensor, but may also include a video camera, a radar, and/or a wireless receiver.

Classifier 514 of control system 502 when implemented in vehicle 600 may be configured to detect objects in the vicinity of vehicle 600 dependent on input signals x. In such an embodiment, output signal y may include information characterizing the vicinity of objects to vehicle 600. Actuator control command 510 may be determined in accordance with this information. The actuator control command 510 may be used to avoid collisions with the detected objects, and may also be used to navigate to enable vehicle 600 to traverse a pre-planned route. Classifier 514 may further be used in performing a dynamic scene reconstruction to provide spatial cues to vehicle 600 as it travels its pre-planned route. For example, using information gathered from LIDAR, the dynamic scene reconstruction carried out by classifier 514 may distinguish static objects, such as buildings, lamp posts, and so on, as well as dynamic objects, such as vehicles in motion or otherwise in traffic. Classifier 514 may also use the dynamic scene reconstruction to identify particular buildings (e.g., when used in combination with GPS data indicating a current location), makes/models of particular vehicles, their respective orientations to vehicle 600, motion with respect to vehicle 600, and so on.

In embodiments where vehicle 600 is an at least partially autonomous vehicle, actuator 504 may be embodied in a brake, a propulsion system, an engine, a drivetrain, or a steering of vehicle 600. Actuator control commands 510 may be determined such that actuator 504 is controlled such that vehicle 600 avoids collisions with detected objects. Detected objects may also be classified according to what classifier 514 deems them most likely to be, such as other vehicles, buildings, and so on. The actuator control commands 510 may be determined depending on the classification. In a scenario where an adversarial attack may occur, the system described above may be further trained to better detect objects or identify a change in lighting conditions or an angle for a sensor or camera on vehicle 600.

In other embodiments where vehicle 600 is an at least partially autonomous robot, vehicle 600 may be a mobile robot that is configured to carry out one or more functions, such as flying, swimming, diving and stepping. The mobile robot may be an at least partially autonomous lawn mower or an at least partially autonomous mobile robot. In such embodiments, the actuator control command 510 may be determined such that a propulsion unit, steering unit and/or brake unit of the mobile robot may be controlled such that the mobile robot may avoid collisions with identified objects.

In another embodiment, vehicle 600 is an at least partially autonomous robot in the form of an industrial robot. In such embodiment, vehicle 600 may use an optical sensor, such as LIDAR, and/or a wireless receiver and/or a transmitter as sensor 506, along with a knowledge of the plant/factory layout to determine a path to traverse from one area to another (e.g., to deliver parts to a particular manufacturing line). Actuator 504 may be a controller for a motor (e.g., an electrical motor) used to provide propulsion power for the partially autonomous robot.

Vehicle 600 may be an at least partially autonomous robot in the form of a mobile robot used in a domestic setting. For example, vehicle 600 may be used in a home and may utilize the various sensor inputs to traverse various pathways in the home to, e.g., bring requested items to an occupant of the home. In utilizing these sensor inputs, control system 502 may perform dynamic scene reconstruction per the disclosure to identify various features (such as walls, particular rooms, doorways, etc.) to determine its location within the home.

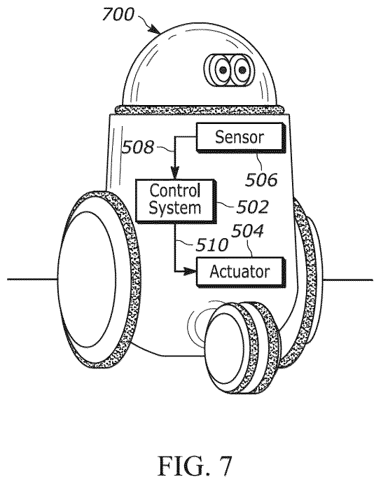

FIG. 7 depicts a schematic diagram of control system 502 configured to control automated personal assistant 700. Control system 502 may be configured to control actuator 504, which is in turn configured to control automated personal assistant 700. Automated personal assistant 700 may be a mobile automated personal assistant configured to carry out tasks within, e.g., a home, office, factory, or other location.

Sensor 506 may be an optical sensor (or LIDAR), a wireless sensor, or some combination thereof configured to provide data to enable dynamic scene reconstruction per the present disclosure. In the case of a LIDAR, sensor 506 may be configured to generate a LIDAR data set from transmitted and received LIDAR signals in accordance with the discussion above. Another type of optical sensor that may be implemented as (or part of) sensor 506 may be configured to receive video images of gestures by a user. A wireless sensor may be used for these purpose.

In some embodiments, automated personal assistant may also include an audio sensor. The audio sensor may be configured to receive a voice command of a user. The automated personal assistant 700 may respond to the command, and may utilize the dynamic scene reconstruction for any movements through the home/building required to carry out the command.

Control system 502 of automated personal assistant 700 may be configured to determine actuator control commands 510 configured to control system 502. Control system 502 may be configured to determine actuator control commands 510 in accordance with sensor signals 508 of sensor 506. Automated personal assistant 700 is configured to transmit sensor signals 508 to control system 502. Classifier 514 of control system 502 may be configured to execute a gesture recognition algorithm to identify gestures made by or audio commands received from a user to determine actuator control commands 510, and to transmit the actuator control commands 510 to actuator 504. Classifier 514 may be configured to retrieve information from non-volatile storage in response to a particular gesture or audio command and to output the retrieved information in a form suitable for reception by the user. The actuator control commands may include commands that result in movement of the automated personal assistant such that it may navigate itself through the home/building without user intervention. As such, dynamic scene reconstruction in accordance with the disclosure may be carried out a continuous basis when moving through the home/building to enable automated personal assistant 700 to know its current location as well as the path to its eventual destination.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A method for reconstructing a dynamic scene using LIDAR (Light Detection and Ranging) data, the method comprising:
generating, using a LIDAR system implemented on a vehicle, point cloud data for an environment including a plurality of objects including static and dynamic objects, wherein the point cloud data comprises a plurality of points in a three-dimensional space;
annotating a plurality of frames based on the point cloud data, wherein the annotated frames include a first annotated frame and a second annotated frame, wherein the first and second annotated frames correspond to point cloud data generated at first and second instances of time, respectively;
estimating a position and orientation for one or more objects of the plurality of objects within each of the first and second annotated frames;
transforming global-referenced coordinates to vehicle-referenced coordinates for each of the one or more objects;
generating, using the first and second annotated frames, a plurality of intermediate frames indicative of respective positions and orientations of the one or more objects between the first and second instances of time;
transforming, for each of the one or more objects and using the plurality of intermediate frames, respective object-referenced coordinates to vehicle-reference coordinates;
performing a first optimization to a mesh of the three-dimensional space, wherein, during the first optimization, the mesh of the three-dimensional space is dynamic and respective positions and orientations of the one or more objects are fixed;
performing a second optimization to the respective positions and orientations of the one or more objects, wherein, during the second optimization, the mesh of the three-dimensional space is fixed and the respective positions and orientations of the one or more objects are dynamic; and
reconstructing the dynamic scene by repeating the performing the first and second optimizations until convergence.

2. The method of claim 1, wherein the LIDAR system comprises a rotating LIDAR sensor.

3. The method of claim 2, wherein the first annotated frame comprises point cloud data generated by the LIDAR sensor when pointing in a particular direction at the first instance of time, and wherein the second annotated frame comprises point cloud data generated by the LIDAR sensor when pointing in the particular direction at the second instance of time, wherein the second instance of time is subsequent to the first instance of time.

4. The method of claim 3, wherein each of the plurality of intermediate frames represent estimated positions and orientations of the one or more objects between the first and second instances of time, when the LIDAR sensor is not pointing in the particular direction.

5. The method of claim 1, further comprising generating meshes for one or more moving objects and generating meshes for one or more non-moving objects.

6. The method of claim 5, further comprising generating the meshes for the one or more moving objects based on a constant velocity of the moving objects.

7. The method of claim 5, further comprising determining point-to-mesh registration for the plurality of points using an iterative closest point method to minimize a difference between two different point clouds of the point cloud data.

8. The method of claim 1, wherein repeating performing the first and second optimizations until convergence comprises repeating the first and second optimizations for a predetermined number of iterations.

9. The method of claim 1, wherein repeating performing the first and second optimizations until convergence comprises performing the first and second optimizations until an error metric is less than an error threshold.

10. A system reconstructing a dynamic scene using LIDAR (Light Detection and Ranging) data, the system comprising:
a LIDAR system implemented on a vehicle and configured to generate point cloud data for an environment including a plurality of objects including static and dynamic objects, the point cloud data comprising a plurality of points in a three-dimensional space;
a processing system coupled to the LIDAR system, the processing system including at least one processor and a memory storing instructions executable by the processor to:
annotate a plurality of frames based on the point cloud data, wherein the annotated frames include a first annotated frame and a second annotated frame, wherein the first and second annotated frames correspond to point cloud data generated at first and second instances of time, respectively;
estimate a position and orientation for one or more objects of the plurality of objects within each of the first and second annotated frames;
transform global-referenced coordinates to vehicle-referenced coordinates for each of the one or more objects;
generate using the first and second annotated frames a plurality of intermediate frames indicative of respective positions and orientations of the one or more objects between the first and second instances of time;
transform, for each of the one or more objects and using the plurality of intermediate frames, respective object-referenced coordinates to vehicle-reference coordinates;
perform a first optimization to a mesh of the three-dimensional space, wherein, during the first optimization, the mesh of the three-dimensional space is dynamic and respective positions and orientations of the one or more objects are fixed;
perform a second optimization to the respective positions and orientations of the one or more objects, wherein, during the second optimization, the mesh of the three-dimensional space is fixed and the respective positions and orientations of the one or more objects are dynamic; and
reconstruct the dynamic scene by repeating the performing the first and second optimizations until convergence.

11. The system of claim 10, wherein the LIDAR system comprises a rotating LIDAR sensor mounted on the vehicle.

12. The system of claim 11, wherein the instructions are further executable to generate the first annotated frame using point cloud data accumulated by the LIDAR sensor when pointing in a particular direction at the first instance of time and generate the second annotated frame using point cloud data accumulated by the LIDAR sensor when pointing in the particular direction at the second instance of time, wherein the second instance of time is subsequent to the first instance of time.

13. The system of claim 12, wherein the instructions are further executable to generate each of the plurality of intermediate frames using estimated positions and orientations of the one or more objects between the first and second instances of time, when the LIDAR sensor is not pointing in the particular direction.

14. The system of claim 10, wherein the instructions are further executable to generate meshes for one or more moving objects and generating meshes for one or more non-moving objects.

15. The system of claim 14, wherein the instructions are further executable to generate the meshes for the one or more moving objects based on a constant velocity of the moving objects.

16. The system of claim 14, wherein the instructions are further executable to determine point-to-mesh registration for the plurality of points using iterative closest point method to minimize a difference between two different point clouds of the point cloud data.

17. The system of claim 10, wherein the instructions are further configured to determine convergence based on repeating the performing the first and second optimizations a predetermined number of times.

18. A non-transitory computer-readable medium storing instructions thereon that, when executed on a processing system, cause the processing system to:
annotate a plurality of frames based on the point cloud data, wherein the annotated frames include a first annotated frame and a second annotated frame, wherein the first and second annotated frames correspond to point cloud data generated at first and second instances of time, respectively, for an environment including a plurality of objects including static and dynamic objects and using a LIDAR (light detection and ranging) system implemented on a vehicle, wherein the point cloud data comprises a plurality of points in a three-dimensional space;
estimate a position and orientation for one or more objects of the plurality of objects within each of the first and second annotated frames;
transform, a global-referenced coordinates to vehicle-referenced coordinates for each of the one or more objects;
generate using the first and second annotated frames a plurality of intermediate frames indicative of respective positions and orientations of the one or more objects between the first and second instances of time;
transform, for each of the one or more objects and using the plurality of intermediate frames, respective object-referenced coordinates to vehicle-reference coordinates;
perform a first optimization to a mesh of the three-dimensional space, wherein, during the first optimization, the mesh of the three-dimensional space is dynamic and respective positions and orientations of the one or more objects are fixed;
perform a second optimization to the respective positions and orientations of the one or more objects, wherein, during the second optimization, the mesh of the three-dimensional space is fixed and the respective positions and orientations of the one or more objects are dynamic; and
reconstruct the dynamic scene by repeating the performing the first and second optimizations until convergence.

19. The computer-readable medium of claim 18, wherein the first annotated frame comprises point cloud data generated by the LIDAR sensor when pointing in a particular direction at the first instance of time, and wherein the second annotated frame comprises point cloud data generated by the LIDAR sensor when pointing in the particular direction at the second instance of time, wherein the second instance of time is subsequent to the first instance of time, and wherein each of the plurality of intermediate frames represent estimated positions and orientations of the one or more objects between the first and second instances of time, when the LIDAR sensor is not pointing in the particular direction.

20. The computer readable medium of claim 18, wherein the instructions are further executable to:
generate meshes for one or more moving objects and generating meshes for one or more non-moving objects, wherein generating the meshes for the one or more moving objects is based on a constant velocity of the moving objects; and
determine point-to-mesh registration for the plurality of points using an iterative closest point method to minimize a difference between two different point clouds of the point cloud data.
